(19) United States
(12) Patent Application Publication
(10) Pub. No.: US 2024/0010120 A1
(43) Pub. Date: Jan. 11, 2024

(54) TRAILER WHEEL LIGHTING SYSTEM

(71) Applicant: TCT Enterprise, Newnan, GA (US)

(72) Inventor: Thomas Alexander, Newnan, GA (US)

(21) Appl. No.: 17/859,519

(22) Filed: Jul. 7, 2022

(51) Int. Cl. B60Q 1/00; B60Q 1/38; B60Q 1/32; B60Q 1/24

(52) U.S. Cl. CPC B60Q 1/0035; B60Q 1/38; B60Q 1/32; B60Q 1/24

(57) ABSTRACT

Embodiments of the present disclosure provide a trailer wheel lighting system comprising: a light enclosure configured to secure to a side panel of a trailer; a lighting apparatus housed in the light enclosure operative such that light emanating from the lighting apparatus is directed in a vertically downward direction to illuminate an area proximate to a wheel of the trailer; and a relay system operative to route electricity from a trailer marker light system and a trailer turn signal system to the lighting apparatus, the relay system comprising: a relay socket configured to receive a plurality of wires, an electromechanical relay secured to the relay socket, the electromechanical relay comprising a time delay actuator.

### FIELD OF DISCLOSURE

The present disclosure generally relates to lighting for vehicle trailers.

### BACKGROUND

A high maintenance cost in wheel-based transportation is the cost of tires and the compounding costs relating to tires. For example, rubbing a tire against a curb when parking may cause a blow out of one or more of the tires of a vehicle. Further, attempting to park a vehicle with low visibility around the tires may cause collateral damage to surrounding objects or structures. This is especially true with wheels on tandem trailers hauled by semi-trucks. In this case, viewing the surroundings of the wheels on the rear tandems from the cab of the truck may prove difficult, if not impossible, particularly in low-light conditions. Improvised solutions, such as a driver manually exiting the cab and looking at the wheels' surroundings is time-ineffective and tedious. Therefore, there is a need to allow a driver of a vehicle to better see the immediate surroundings of the most disparate located tires of their vehicle, without having to exit their driver's seat.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In one embodiment, the present disclosure may provide a trailer wheel lighting system comprising: a light enclosure configured to secure to a side panel of a trailer; a lighting apparatus housed in the light enclosure operative such that light emanating from the lighting apparatus is directed in a vertically downward direction to illuminate an area proximate to a wheel of the trailer; and a relay system operative to route electricity from a trailer marker light system and a trailer turn signal system to the lighting apparatus, the relay system comprising: a relay socket configured to receive a plurality of wires, an electromechanical relay secured to the relay socket, the electromechanical relay comprising a time delay actuator.

In another embodiment, the present disclosure may provide a trailer wheel lighting system comprising: a light enclosure comprising: an inner housing comprising an aperture disposed on a bottom portion of the light enclosure, an outer housing configured to secure to a side panel of a trailer above one or more vehicle tires; a lighting apparatus disposed in the aperture of the inner housing such that light emanating from the lighting apparatus is directed in a vertically downward direction to an area proximate to the one or more vehicle tires; a first end of one or more lighting apparatus wires secured to the lighting apparatus; a second end of the one or more lighting apparatus wires secured to a relay socket; a first end of one or more turn signal wires configured to secure to a trailer turn signal system; a second end of one or more turn signal wires secured to the relay socket; a first end of one or more trailer marker light wires configured to secure to a trailer turn signal system; a second end of one or more trailer marker light wires secured to the relay socket; and a relay system operative to route electricity from the trailer turn signal system and the trailer marker light system to the lighting apparatus, the relay system comprising: the relay socket in operative communication with the following: the second end of the one or more lighting apparatus wires, the second end of the one or more trailer marker light wires, and the second end of one or more turn signal wires, an electromechanical relay secured to the relay socket, the electromechanical relay comprising a time delay actuator.

In another embodiment, the present disclosure may provide a trailer wheel lighting system comprising: a light enclosure configured to secure to a side panel of a trailer above one or more vehicle tires; a lighting apparatus disposed within the light enclosure operative to emanate light in a vertically downward direction, the lighting apparatus comprising one or more lighting apparatus wires secured on one end to a relay socket; and a relay system operative to route electricity from a trailer turn signal system and a trailer marker light system to the lighting apparatus, the relay system comprising: the relay socket in operative communication with the following: the one or more lighting apparatus wires, the one or more trailer marker light wires, and one or more turn signal wires, an electromechanical relay secured to the relay socket configured to route electrical current from the one or more turn signal wires to the one or more lighting apparatus wires, the electromechanical relay comprising a time delay actuator, and a relay housing enveloping the relay socket, the electromechanical relay, at least a portion of each of the one or more turn signal wires, and at least a portion of each of the one or more lighting apparatus wires.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a trailer wheel lighting system 100 secured on a vehicle trailer;

FIG. 2 further illustrates the trailer wheel lighting system 100; and

FIG. 3 illustrates method 1000 for assembling and operating a trailer wheel lighting system 100.

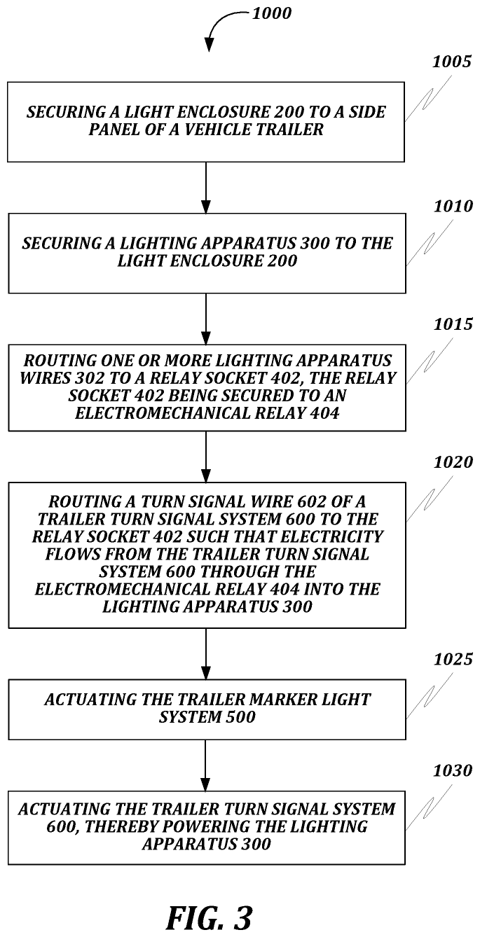

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of lighting for vehicle trailers, embodiments of the present disclosure are not limited to use only in this context.

### I. Apparatus Overview

This overview is provided to introduce a selection of concepts in a simplified form that are further described below. This overview is not intended to identify key features or essential features of the claimed subject matter. Nor is this overview intended to be used to limit the claimed subject matter's scope.

The trailer wheel lighting system 100 may assist drivers of trailers in seeing objects when turning into parking lots. The system 100 may further help drivers to avoid rubbing tires on curbs or other objects on or near the parking location, which can cause blow outs from side wall punctures of the tires, due to the improved lighting around the tires.

The lighting components of the system 100 may be located above the tires of a tandem trailer axle. The lighting components may be configured to shine in a downward direction as to illuminate the tires and/or the area near the tires where the tires contact the ground.

A relay box housing a relay and a relay socket may be mounted close to a side blinker (e.g., a turn indicator light) and/or a marker light of a vehicle trailer. Wires may electrically connect a relay with at least one of the trailer light systems. The relay may receive power from the marker light circuit and/or the blinker light circuit to power the relay and subsequently the trailer wheel lighting system 100. The blinker and/or the marker lights, when applied, may activate a time delay relay to turn on lights above the tandem axles of the trailer wheel lighting system 100. As a particular example, the relay may receive a constant voltage from the marker lights and an activation signal from the turn signal. In this way, the relay may activate the trailer wheel lighting system 100 in response to both the marker lights and the blinker being activated. The relay may function to maintain the illumination of the trailer wheel lighting system 100 between momentary fluctuations of the turn signal (e.g., while the turn signal is blinking off).

Embodiments of the present disclosure may comprise methods, systems, and components comprising, but not limited to, at least one of the following:
A. A Light Enclosure 200;
B. A Lighting Apparatus 300;
C. A Relay System 400;

In some embodiments, the present disclosure may provide an additional set of components for further facilitating the system. The additional set of components may comprise, but not be limited to:
D. A Trailer Marker Light System 500; and
E. A Trailer Turn Signal System 600.

Details with regards to each component is provided below. Although components are disclosed with specific functionality, it should be understood that functionality may be shared between components, with some functions split between components, while other functions duplicated by the components. Furthermore, the name of the component should not be construed as limiting upon the functionality of the component. Moreover, each stage disclosed within each component can be considered independently without the context of the other stages within the same component or different components. Each stage may contain language defined in other portions of this specifications. Each stage disclosed for one component may be mixed with the operational stages of another component. In the present disclosure, each stage can be claimed on its own and/or interchangeably with other stages of other components.

The following depicts an example of a method of a plurality of methods that may be performed by at least one of the aforementioned components. Various hardware components may be used at the various stages of operations disclosed with reference to each component. For example, although methods may be described to be performed by a single apparatus, it should be understood that, in some embodiments, different operations may be performed by different apparatuses in operating in conjunction with each other. For example, the trailer wheel lighting system 100 may be employed in the performance of some or all of the stages disclosed with regard to the methods. Similarly, one apparatus may be employed in the performance of some or all of the stages of the methods. As such, the apparatus may comprise at least one of the architectural components disclosed herein.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

Consistent with embodiments of the present disclosure, a method may be performed by at least one of the aforementioned components. The method may be embodied as, for example, but not limited to, computer instructions, which when executed, perform the method. The method may comprise the following stages:
securing a light enclosure 200 to a side panel of a vehicle trailer;
securing a lighting apparatus 300 to the light enclosure 200;
routing one or more lighting apparatus wires 302 to a relay socket 402, the relay socket 402 being secured to an electromechanical relay 404;
routing a turn signal wire 602 of a trailer turn signal system 600 to the relay socket 402 such that electricity flows from the trailer turn signal system 600 through the electromechanical relay 404 into the lighting apparatus 300; and
Responsive to the trailer turn signal system 600 and/or the trailer marker light system 500, powering the lighting apparatus 300.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. System Configuration

One possible embodiment of a component of the system may be provided by the products and services provided by TCT Enterprises LLC.

It is noted that the terms “trailer”, “tandem trailer”, “truck trailer”, “vehicle trailer” and “tandem” may be used interchangeably and/or have the same or similar meanings.

It is further noted that the terms “truck”, semi-truck”, “tractor”, “tractor unit”, and “big rig” may be used interchangeably and/or have the same or similar meanings.

It is further noted that the term “wheel(s)” may be used to mean, be used interchangeably with, and/or be used in combination thereof, “tire(s)”, “wheel system”, “tandem axle(s)”, and “axle(s)”.

Accordingly, embodiments of the present disclosure provide a system comprised of a distributed set of components, including, but not limited to:

A. Light Enclosure 200

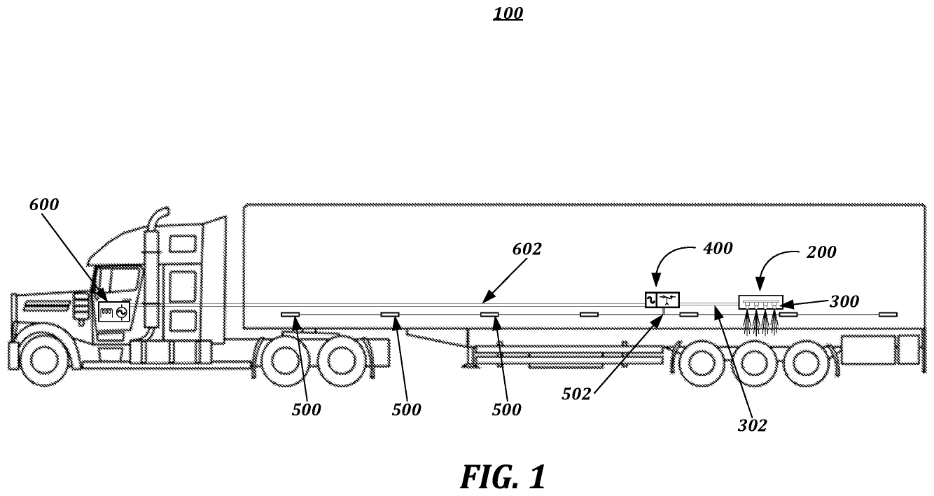

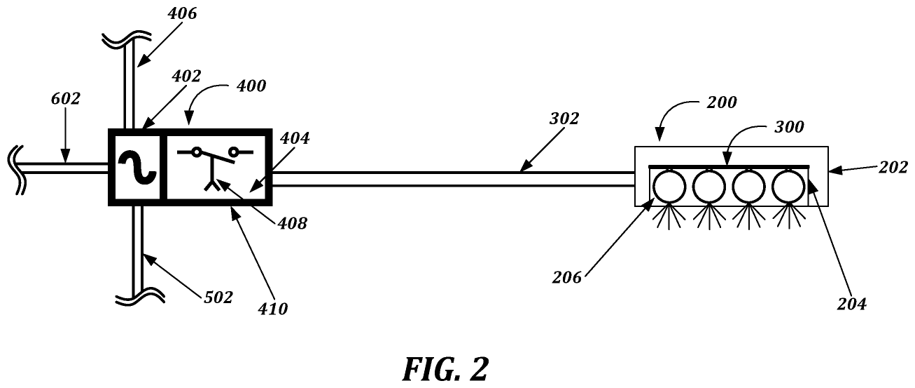

FIGS. 1 and 2 illustrate the light enclosure 200 consistent with embodiments of the present disclosure. The light enclosure 200 may be used to secure to a side (and/or side panel) of a vehicle trailer. In some embodiments, the light enclosure 200 may be disposed above one or more wheels, trailer wheels, and/or the outermost wheels of a tandem wheel system. In some embodiments, at least a portion of the light enclosure 200 may be waterproof and/or water resistant.

The lighting enclosure 200 may be shaped and/or oriented such that a lighting apparatus 300 housed in the lighting enclosure 200 provides and/or directs light and/or illumination in a substantially downward (and/or vertical and/or negative Y-axis) direction towards the ground in an area substantially near where the tandem wheels contact the ground. In such embodiment, the light emanating from the lighting apparatus 300 may illuminate the wheels and tangential areas around the wheels.

In further embodiments, the light enclosure 200 may comprise an aperture 206, illustrated at least in FIG. 2. The aperture 206 may be used to house and/or receive at least a portion of the lighting apparatus 300. In some embodiments, an opening of the aperture 206 may be disposed on a bottom portion of the lighting enclosure 200.

In further embodiments, the light enclosure 200 may comprise an outer housing 202, illustrated at least in FIG. 2. At least a portion of the outer housing 202 may be used to secure to the side of the vehicle trailer. The outer housing 202 may be further used to provide protection for the lighting apparatus 300 and/or other components housed in the light enclosure 300 from external corrosive and/or destructive elements. In some embodiments, the outer housing 202 may include a translucent or transparent cover or lens that substantially surrounds at least a portion of the lighting apparatus 300. In some embodiments the lens may be substantially clear. In other embodiments, the lens may include a color filter, such as a yellow or amber color filter.

In further embodiments, the light enclosure 200 may comprise an inner housing 204, illustrated at least in FIG. 2. The inner housing 204 may be used to house and/or receive at least a portion of the lighting apparatus 300. In some embodiments, the inner housing 204 may be configured to form a full enclosure and/or seal around the components housed in the inner housing 204.

In some embodiments, the inner housing 204 may be embodied as cavity.

B. Lighting Apparatus 300

FIGS. 1 and 2 illustrate the lighting apparatus 300 consistent with embodiments of the present disclosure. The lighting apparatus 300 may be used to produce light and/or illuminate a predetermined area with a predetermined intensity.

In some embodiments, the lighting apparatus 300 may include any standard and/or suitable type of light source configured to emit light in the visible spectrum. As examples, the light source may emit white light, yellow light, amber light, or any other color of light, as permitted by highway safety rules. The light source may include any suitable light source such as, but not limited to, for example:
a. Light Emitting Diodes (LED),
b. fluorescent,
c. halogen,
d. incandescent, and/or
e. any other suitable type of light source.

In further embodiments, the lighting apparatus 300 may be any number of suitable voltages, watts, amps, and/or lumens. By way of nonlimiting example, the lighting apparatus 300 may be an LED with a minimum of 1500 lumens.

In further embodiments, at least a portion of the lighting apparatus 300 may be housed in the light enclosure 200.

In further embodiments, the lighting apparatus 300 may comprise one or more lighting apparatus wires 302, illustrated at least in FIG. 2. In some embodiments, a first proximal end of each of the one or more lighting apparatus wires 302 may be operatively connected and/or secured to the lighting apparatus 300. The one or more electrical wires may be any suitable wire(s) to provide electrical transmission and/or communication for lighting devices. The one or more lighting apparatus wires 302 may be used to power, operate, and/or send and receive electrical signals to and from the lighting apparatus 300. In some embodiments, a second distal end of each of the one or more lighting apparatus wires 302 may be secured and/or operatively connected to the relay system 400. The one or more lighting apparatus wires 302 may be used to route power and/or electricity from the relay system 400 to the lighting apparatus 300.

C. Relay System 400

FIGS. 1 and 2 illustrate the relay system 400 consistent with embodiments of the present disclosure. The relay system 400 may be used to route electricity from the trailer marker light system 500, the trailer turn signal system 600, and/or any other suitable external power source, to the lighting apparatus 300.

In some embodiments, the relay system 400 may comprise a relay socket 402, illustrated at least in FIG. 2. The relay socket 402 may be used to receive one or more electrical wires. In some embodiments, the relay socket 402 may be used to establish an intermediate and/or semi-permanent connection between the one or more light apparatus wires 302, a ground wire 406, one or more trailer marker light wires 502, and/or one or more turn signal wires 602.

In some embodiments, the relay system 400 may comprise an electromechanical relay 404, illustrated at least in FIG. 2. In further embodiments, the electromechanical relay 404 may be secured to and/or in operative communication with, the relay socket 402. In further embodiments, the electromechanical relay 404 may be a type of relay which functions via a magnetic field produced by an electromagnetic coil when a control signal is applied thereto. The electromechanical relay 404 may be used to control, step up, step down, turn on, and/or turn off an electrical current and/or a predetermined amount of electric current emanating from a power source and/or electrical wire. In further embodiments, the electromechanical relay 404 may comprise a time delay actuator 408, illustrated at least in FIG. 2. The time delay actuator 408 may be configured to delay cutoff of electrical current flowing into the lighting apparatus for a predetermined amount of time (upon a termination of electrical current flow). The predetermined amount of time to delay cutoff may be adjustable (e.g., manually and/or electronically adjustable). By way of nonlimiting example, the predetermined amount of time to delay cutoff may be adjustable from three seconds to ten minutes. As a particular example, the relay system 400 may be wired to receive a constant voltage from the vehicle electrical system (e.g., the trailer marker light system 500), and the time delay actuator 408 may be wired to a different part of the vehicle electrical system (e.g., the trailer turn signal system 600), such that when both the trailer marker light system and the trailer turn signal system are active, the relay system will provide power to the lighting apparatus 300, and will continue to apply power to the lighting apparatus for the predetermined amount of time after the relay system stops receiving power from the trailer turn signal system. In this way, the trailer wheel lighting system 100 may activate only when the trailer marker light system 500 is active (e.g., when it is dark outside) and when the trailer turn signal system 600 is applied. In other embodiments, the trailer wheel lighting system 100 may activate responsive to either the trailer marker light system 500 being active or the trailer turn signal system 600 being applied.

In some embodiments, the relay system may comprise a relay housing 410, illustrated at least in FIG. 2. The relay housing 410 may be used to house and/or protect elements of the relay system 400 such as, but not limited to, the electromechanical relay 404 and the relay socket 402. The relay housing 410 may be configured to receive the relay socket 402, the electromechanical relay 404, and at least a portion of the plurality of any of the aforementioned wires. In some embodiments, at least a portion of the relay housing 410 may be waterproof and/or water resistant.

D. Trailer Marker Light System 500

FIGS. 1 and 2 illustrate trailer marker light system 500 consistent with embodiments of the present disclosure. The trailer marker light system 500 may be used to illuminate at least a portion of a trailer via a plurality of lighting sources. The trailer marker light system 500 may be further used to power and/or actuate the lighting apparatus 300.

In some embodiments, the trailer marker light system 500 may comprise one or more trailer marker light wires 502, illustrated at least in FIG. 2. The one or more turn trailer marker light wires 502 may be used to transmit electrical signals and/or be in operative communication with a marker light actuator. In some embodiments, the trailer marker light wires 502 may be part of a wire harness arranged within the trailer.

In some embodiments, the trailer marker light system 500 may be in operative (and/or electrical) communication with and/or power the lighting apparatus 300. That is, the trailer marker light system 500 may be in operative communication with the lighting apparatus 300 via the one or more trailer marker light wires 502 being secured to the relay socket 402 and/or relay system 400. In this embodiment, power and/or electricity may be routed from the trailer marker light system 500, through the one or more trailer marker light wires 502, into the relay system 400 (via a portion of the relay socket 402 housing and/or receiving the one or more trailer marker light wires 502, routed into the electromechanical relay 404, then routed into another portion of the relay socket 402 housing and/or receiving the one or more lighting apparatus wires 302), then routed out of the relay system 400 through one or more of the lighting apparatus wires 302, ending in the lighting apparatus 300.

E. Trailer Turn Signal System 600

FIGS. 1 and 2 illustrate trailer turn signal system 600 consistent with embodiments of the present disclosure. The trailer turn signal system 600 may be used to illuminate one or more turn signal lights operative to indicate a vehicle and/or trailer's intent to turn in a predetermined direction. In some embodiments, the turn signal system 600 may further be used as hazard lights on the vehicle to warn any surrounding vehicles that there is an issue with the vehicle. The trailer turn signal system 600 may be further used to power and/or actuate the lighting apparatus 300.

In some embodiments, the trailer turn signal system 600 may comprise one or more turn signal wires 602, illustrated at least in FIG. 2. The one or more turn signal wires 602 may be used to transmit electrical signals and/or be in operative communication with a turn signal actuator and a turn signal. In some embodiments, the trailer turn signal wires 602 may be part of a wire harness arranged within the trailer.

In some embodiments, the trailer turn signal system 600 may be in operative (and/or electrical) communication with and/or power the lighting apparatus 300. The trailer turn signal system 600 may be in operative communication with the lighting apparatus 300 via the one or more turn signal wires 602 being secured to the relay socket 402.

In further embodiments, the trailer turn signal system 600 may be in operative communication with and/or utilize portions of the trailer marker light system 500 and vice versa.

### III. Apparatus/System Use

Embodiments of the present disclosure provide a system operative by a set of methods comprising instructions configured to operate the aforementioned components in accordance with the methods. The following depicts an example of a method of a plurality of methods that may be performed by at least one of the aforementioned components. Various hardware components may be used at the various stages of operations disclosed with reference to each component.

For example, although methods may be described to be performed by a single component, it should be understood that, in some embodiments, different operations may be performed by different components in operative relation with one another. For example, an apparatus may be employed in the performance of some or all of the stages disclosed with regard to the methods. As such, the apparatus may comprise at least one architectural component disclosed herein.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

Consistent with embodiments of the present disclosure, a method 1000 for assembling and operating a trailer wheel lighting system 100 may be performed by at least one of the aforementioned components. The method 1000 may comprise the following stages:
1. 1005—Securing a light enclosure 200 to a side panel of a vehicle trailer (such that the light enclosure is disposed substantially above a wheel of the trailer);
2. 1010—Securing a lighting apparatus 300 to the light enclosure 200,
   a. (Optional) such that the light enclosure 300 envelops the lighting apparatus 200 on five sides, the lighting apparatus being externally visible from a bottom view,
   b. (Alternate) the lighting apparatus 300 being oriented such that, when illuminated, light emanates in a substantially downward (negative Y-axis) direction;
3. 1015—Routing one or more lighting apparatus wires 302 to a relay socket 402, the relay socket 402 being secured to an electromechanical relay 404,
   a. (Optional) the electromechanical relay having a time delay actuator operative to delay cutoff of electrical current flowing into the lighting apparatus 300 for a predetermined amount of time,
   b. (Alternate) securing a first end of each of one or more lighting apparatus wires 302 to the lighting apparatus 300, and securing a second end of each of the one or more lighting apparatus wires 302 to a relay socket 402, the relay socket 402 being secured to an electromechanical relay 404;
4. 1020—Routing (and/or securing) a turn signal wire 602 of a trailer turn signal system 600 to the relay socket 402 such that electricity flows from the trailer turn signal system 600 through the electromechanical relay 404 (via the relay socket 402), into the lighting apparatus 300 (via the one or more lighting apparatus wire 302);
   a. (Alternate) Routing (and/or securing) a trailer marker light wire 502 of a trailer marker light system 500 to the relay socket 402 such that electricity flows from the trailer marker light system 500 through the electromechanical relay 404 (via the relay socket 402), into the lighting apparatus 300 (via the one or more lighting apparatus wire 302); and
5. 1025—Actuating the trailer marker light system 500;
6. 1030—Actuating the trailer turn signal system 600, thereby powering the lighting apparatus 300,
   a. wherein the electromechanical relay 400 is configured to provide constant voltage from the trailer marker light system 500 and/or the trailer turn signal system 600, thereby emanating a consistent flow of light from the lighting apparatus 300 responsive to the trailer turn signal system 600 being actuated;
   b. wherein the light enclosure 200 directs light emanating (and/or originating) from the lighting apparatus 300 such that the wheels disposed below the lighting apparatus 300 and light enclosure 200 are illuminated.

Although the stages are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

### IV. Aspects

The following disclose various Aspects of the present disclosure. The various Aspects are not to be construed as patent claims unless the language of the Aspect appears as a patent claim. The Aspects describe various non-limiting embodiments of the present disclosure.
Aspect 1. A trailer wheel lighting system comprising:
   a light enclosure configured to secure to a side panel of a trailer;
   a lighting apparatus housed in the light enclosure operative such that light emanating from the lighting apparatus is directed in a vertically downward direction; and
   a relay system operative to route electricity from a trailer marker light system (and a trailer turn signal system) to the lighting apparatus, the relay system comprising:
      a relay socket configured to receive a plurality of electrical wires,
      an electromechanical relay secured to the relay socket, the electromechanical relay comprising a time delay actuator.
Aspect 2. The trailer wheel lighting system of any preceding aspect, wherein the trailer wheel lighting system is powered via an electrical current traveling from the trailer marker light system to the voltage relay system.
Aspect 3. The trailer wheel lighting system of any preceding aspect, wherein the trailer wheel lighting system is powered via an electrical current traveling from the trailer turn signal system to the voltage relay system.
Aspect 4. The trailer wheel lighting system of any preceding aspect, wherein the time delay actuator is configured to delay cutoff of electrical current flowing into the lighting apparatus for a predetermined amount of time upon a termination of electrical current flowing into the relay system.
Aspect 5. The trailer wheel lighting system of any preceding aspect, wherein the light enclosure is waterproof.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A trailer wheel lighting system comprising:
a light enclosure configured to secure to a side panel of a trailer;
a lighting apparatus housed in the light enclosure operative such that light emanating from the lighting apparatus is directed in a vertically downward direction to illuminate an area proximate to a wheel of the trailer; and
a relay system operative to route electricity from a trailer marker light system and a trailer turn signal system to the lighting apparatus, the relay system comprising:
a relay socket configured to receive a plurality of wires,
an electromechanical relay secured to the relay socket, the electromechanical relay comprising a time delay actuator.

2. The trailer wheel lighting system of claim 1, wherein the lighting apparatus is actuated via activation of the trailer turn signal system.

3. The trailer wheel lighting system of claim 2, wherein the lighting apparatus is actuated via activation of the trailer marker light system.

4. The trailer wheel lighting system of claim 2, wherein the trailer turn signal system is in operative communication with the relay system via one or more turn signal wires secured to the relay socket. S. The trailer wheel lighting system of claim 3, wherein the trailer marker light system is in operative communication with the relay system via one or more trailer marker light wires secured to the relay socket.

6. The trailer wheel lighting system of claim 1, wherein the time delay actuator is configured to delay cutoff of electrical current flowing into the lighting apparatus for a predetermined amount of time.

7. The trailer wheel lighting system of claim 6, wherein the predetermined amount of time to delay cutoff of electrical current flowing into the lighting apparatus is adjustable.

8. The trailer wheel lighting system of claim 1, wherein the lighting apparatus and lighting enclosure is disposed above one or more vehicle tires.

9. The trailer wheel lighting system of claim 1, wherein the light emanating from the lighting apparatus is at least 1500 lumens.

10. The trailer wheel lighting system of claim 1, wherein the relay system comprises a relay system housing configured to receive the relay socket, the electromechanical relay, and at least a portion of the plurality of wires.

11. The trailer wheel lighting system of claim 1, wherein the plurality of wires comprises:
one or more ground wires,
one or more trailer turn signal wires,
one or more trailer marker light wires, and
one or more trailer wheel lighting wires.

12. A trailer wheel lighting system comprising:
a light enclosure comprising:
an inner housing comprising an aperture disposed on a bottom portion of the light enclosure,
an outer housing configured to secure to a side panel of a trailer above one or more vehicle tires;
a lighting apparatus disposed in the aperture of the inner housing such that light emanating from the lighting apparatus is directed in a vertically downward direction to an area proximate to the one or more vehicle tires;
a first end of one or more lighting apparatus wires secured to the lighting apparatus;
a second end of the one or more lighting apparatus wires secured to a relay socket;
a first end of one or more turn signal wires configured to secure to a trailer turn signal system;
a second end of one or more turn signal wires secured to the relay socket;
a first end of one or more trailer marker light wires configured to secure to a trailer turn signal system;
a second end of one or more trailer marker light wires secured to the relay socket; and
a relay system operative to route electricity from the trailer turn signal system and the trailer marker light system to the lighting apparatus, the relay system comprising:
the relay socket in operative communication with the following:
the second end of the one or more lighting apparatus wires,
the second end of the one or more trailer marker light wires, and
the second end of one or more turn signal wires,
an electromechanical relay secured to the relay socket, the electromechanical relay comprising a time delay actuator.

13. The trailer wheel lighting system of claim 12, wherein the light emanating from the lighting apparatus is at least 1500 lumens.

14. The trailer wheel lighting system of claim 12, wherein the trailer wheel lighting system is actuated via activation of the trailer marker light system and the trailer turn signal system, the activation causing at least a portion of electrical current flowing from the trailer marker light system to be routed through the relay system, to the lighting apparatus.

15. The trailer wheel lighting system of claim 12, wherein the time delay actuator is configured to delay cutoff of electrical current flowing into the lighting apparatus for a predetermined amount of time.

16. The trailer wheel lighting system of claim 12, wherein light enclosure is waterproof.

17. A trailer wheel lighting system comprising:
a light enclosure configured to secure to a side panel of a trailer above one or more vehicle tires;
a lighting apparatus disposed within the light enclosure operative to emanate light in a vertically downward direction, the lighting apparatus comprising one or more lighting apparatus wires secured on one end to a relay socket; and
a relay system operative to route electricity from a trailer turn signal system and a trailer marker light system to the lighting apparatus, the relay system comprising:
the relay socket in operative communication with the following:
the one or more lighting apparatus wires,
the one or more trailer marker light wires, and
one or more turn signal wires,
an electromechanical relay secured to the relay socket configured to route electrical current from the one or more turn signal wires to the one or more lighting apparatus wires, the electromechanical relay comprising a time delay actuator, and
a relay housing enveloping the relay socket, the electromechanical relay, at least a portion of each of the one or more turn signal wires, and at least a portion of each of the one or more lighting apparatus wires.

18. The trailer wheel lighting system of claim 17, wherein the trailer wheel lighting system is actuated via activation of the trailer turn signal system and the trailer marking system, the activation causing at least a portion of electrical current flowing from the trailer turn signal system to be routed, via the one or more turn signal wires, through the relay system, to the lighting apparatus, via the one or more lighting apparatus wires.

19. The trailer wheel lighting system of claim 17, wherein the time delay actuator is configured to delay cutoff of electrical current flowing into the lighting apparatus for a predetermined amount of time.

20. The trailer wheel lighting system of claim 17, wherein the relay system is further operative to route electricity from a trailer marker light system to the lighting apparatus, such that the trailer wheel lighting system is actuated via activation of the trailer marker light system and the trailer turn signal system.
